(19) United States
(12) Patent Application Publication
(10) Pub. No.: US 2024/0028457 A1
(43) Pub. Date: Jan. 25, 2024

(54) METHOD AND DEVICE FOR DETECTING ERRORS IN ROUTES AND CALCULATIONS WITHIN AN FPGA

(71) Applicant: dSPACE GmbH, Paderborn (DE)

(72) Inventors: Heiko KALTE, Paderborn (DE); Dominik LUBELEY, Paderborn (DE)

(73) Assignee: dSPACE GmbH, Paderborn (DE)

(21) Appl. No.: 18/224,778

(22) Filed: Jul. 21, 2023

(30) Foreign Application Priority Data
Jul. 22, 2022 (DE) 10 2022 118 375.0

(51) Int. Cl. G06F 11/14; G06F 11/10

(52) U.S. Cl. CPC G06F 11/1438; G06F 11/10

(57) ABSTRACT

In an FPGA, errors within an FPGA are detected by: providing at least one computation operation in the configurable logic block, a parity-invariant additional result being added, the parity-invariant additional result being provided by picking off an XOR bit of an XOR operation of the full adder, the XOR operation comprising at least two input signals; forming the parity of the XOR operation of the input signals with the aid of the following formula, and providing a parity signal: Parity(XOR(x1,x2)); calculating the XOR operation of the carried parities (Parity(x1), Parity(x2)) of the input signals with the aid of the device for checking the parity, using the following formula: XOR(Parity(x1), Parity(x2)); checking the parity, using a check of the truth of the following formula: XOR(Parity(x1), Parity(x2))==Parity(XOR(x1,x2); detecting an error in routes/calculations within the FPGA in the presence of an untrue statement of the formula of the preceding step.

This nonprovisional application claims priority under 35 U.S.C. § 119(a) to German Patent Application No. 10 2022 118 375.0, which was filed in Germany on Jul. 22, 2022, and which is herein incorporated by reference.

### BACKGROUND OF THE INVENTION

### Field of the Invention

The invention relates to a method as well as a device for detecting errors in routes and calculations within an FPGA.

### Description of the Background Art

An FPGA is an integrated circuit in digital technology, to which a logic circuit may be loaded. In contrast to programming computers, microcontrollers, and controllers, the term “programming” in FPGAs does not only mean specifying time sequences but also defining the targeted circuit structure. This circuit structure is formulated with the aid of a hardware description language and then translated by software into a configuration file, which specifies how the elements in the FPGA are to be connected. In FPGA programming, a description of the hardware structure is thus generated, which is then transferred to the actual FPGA with the aid of synthesis and routing tools. This hardware description typically takes place in special languages, such as VHDL or Verilog. Instead of “FPGA programming,” this is therefore also referred to as an “FPGA configuration.” In contrast to programming computers, microprocessors and controllers, the FPGA programming is thus not aimed at a predefined operating system and a driver basis. Instead, the FPGA programming is aimed at defining structures in the semiconductor, which carry out the intended functions later on. In this way, a degree of specialization and parallelism may be achieved, which is difficult to reach by conventional, prefabricated microprocessors.

FPGAs are used, for example, in rapid control prototyping (RCP) platforms for the model-based design of processor- and FPGA-based real-time applications. For example, programming block sets for Simulink are available for developing the FPGA-based real-time applications, which allow even developers without any FPGA knowledge to create comprehensive FPGA designs, build them at the press of a button, and download them to the prototyping platform. The prototyping platform is then also used as a control unit in real-world scenarios. FPGA-based systems for aerospace applications are known which make it possible to replace individual hardware modules with hardware reconfiguration mechanisms as needed and at runtime. This is interesting, above all, in the application field of communication satellites, for example to adapt the implemented digital signal processing methods during operation by means of updates or even in the case of new communication standards. Systems of this type also operate in an environment with increased radiation. The radiation effects occurring with increased radiation pose a major challenge to the reliability of the FPGA hardware. One of these radiation effects is the total ionizing dose (TID), which is caused by the radiation of charged particles and gamma rays in outer space. This radiation releases energy in that it causes an ionization in the material. The ionization may change the charge excitation, charge transport, bonding, and decay properties of the material and has a negative effect on the parameters of the chip. The TID is the cumulative ionizing radiation which an electronic chip receives over a certain period of time, normally the mission duration. The damage caused thereby is dependent on the radiation quantity and is expressed in the radiation absorbed dose (RAD). Depending on the radiation tolerance for TID, functional or parameter failures in the chip may occur. The typical parameters in FPGAs impaired by radiation include the increase of the signal propagation time, which reduces the chip power. Leakage currents following a high TID load are a further failure mechanism.

Single event effects (SEEs) are another type of radiation effect. These are sudden disturbances, transients, or permanent damage due to particle radiation such as protons, heavy ions, and alpha particles, which strike sensitive areas of the transistor and may cause various failures. There are different forms of SEEs, including single event upsets (SEUs), which occur when high-energy ionizing particles, such as heavy ions, alpha particles, or protons strike a circuit or penetrate an integrated circuit. They cause disturbances in the system logic.

A single-event latch-up (SEL) is also problematic, a state in which the functionality of the chip is lost due to a high-current state triggered by a single event. An SEL may but does not have to be destructive. In a destructive latch-up event, the current does not drop back to the nominal value. In a non-destructive latch-up state, the high current returns to the nominal value after a deactivation of the FPGA followed by a reactivation. Other possible error sources are, for example, further radiation-induced glitches, such as single error transients (SETs) as well as power rail glitches, power supply glitches/brownouts (bunch discharge), and meta-stable states due to design errors. The worst case is, for example, when a finite state machine (FSM) reaches an invalid state from which it does not emerge. Possible error bits in the FPGA may occur, for example, in lookup tables (LUTs), configuration bits in configurable logic blocks (CLBs), flip-flops, and in routing (inter-/intra-CLB connections) as well as connections of CLBs and IOBs (input/output buffers)/pins). The majority of configurable bits in the FPGA are in the routing logic.

To ensure the reliability of the FPGA hardware, methods for precise FPGA power analysis as well as configuration validation and watchdog methods are already known from the prior art. The power analysis methods make it possible to rule out an overload situation in the FPGA logic, which, in contrast to a processor, is not only device-specific but also dependent on the configured logic. The configuration validation and watchdog methods make it possible to detect an error situation and permit a self-defined failsafe behavior to be initiated by a failsafe signal. These approaches are no longer sufficient in more safety-critical applications and, in particular ones more susceptible to faults. The FPGA must control itself, ideally even correct itself. In the prior art, this is done, for example, via scrubbing, the cyclical reading out of the entire FPGA configuration and (partial) reprogramming if a CRC was faulty during the readout. Runtime values may not be taken into account. To protect the runtime values, the triple modular redundancy (TMR) is often used. This is an error-tolerant form of the N-modular redundancy, in which three systems carry out a process, and the result is processed by a system with a “majority voter” to generate a single output. If one of the three systems fails, the two other systems may correct and mask the error. A block diagram of a TMR with a tripling of the logic having a subsequent majority voter 1 is illustrated in FIG. 1. The TMR concept may be applied to many forms of redundancy, for example software redundancy in the form of N-version programming, and is often found in error-tolerant computer systems. Single event upsets (SEUs) may be captured in one of the three paths. However, this method illustrated in FIG. 1 has an overhead of >200%. Space satellite systems frequently use TMR, even though satellite RAM generally uses Hamming error correction. Some ECC memories use triple modular redundancy hardware (instead of the more conventional Hamming codes), since triple modular redundancy hardware is faster than Hamming error correction hardware. The resource consumption of TMR is prohibitive for many ground-based applications.

On the processor side, for example, a real-time interface watchdog block set may be used as a reference for the functional safety of processor-based RCP systems. The control of typical monitoring values, such as supply voltages, as well as a verification of the FPGA configuration and possibly reprogramming of the FPGA are viewed as the prior art. With the exception of a temperature monitoring and emergency shutoff, no functional safety during operation exists in the prior art for FPGA-based rapid control prototyping. To be able to detect errors during the storage or transmission of a value, checksums are used in many technical applications. Parity, i.e., the odd or even number of high bits in a data word, is the simplest form of a checksum which is able to detect the individual changed bits or an odd number of flipped bits, i.e., single event upsets (SEUs).

However, techniques for correcting configuration upsets do not always offer a fast remedy, and several thousand or million clock cycles may go by before the problem is detected and eliminated. During this time, the FPGA may demonstrate an incalculable and uncontrollable behavior. If an SEU results in a total failure of a system (e.g., computer crash), this is referred to as a single event functional interrupt (SEFI). Redundancies in FPGA architectures may be used to prevent SEUs and SEFIs from having an effect. Configuration changes, on the other hand, may cause a latch-up of the chip and make it necessary to restart the system with a corresponding downtime. In the worst case, a permanent error in the function of the chip (or system) may remain. Scenarios like these are sufficiently well known and have produced a multiplicity of concepts for checking for errors as well as for implementing redundant functions on the system level, which prevent a malfunction or damage to system parts.

### SUMMARY OF THE INVENTION

It is therefore an object of the invention to provide a method as well as a device, in which errors in routes and calculations within an FPGA are detected with as little effort as possible and a significantly reduced resource consumption compared to the previous approaches from the prior art.

According to a first aspect, the object according to the invention is achieved by a method for detecting errors in routes and calculations within an FPGA, the method comprising the following steps: providing an FPGA with at least one configurable logic block for processing data signals; providing at least one computation operation in the configurable logic block, the computation operation being implemented with the aid of at least one full adder, a parity-invariant additional result being added to the full adder, the parity-invariant additional result being provided by picking off an XOR bit of an XOR operation of the full adder, the XOR operation comprising at least two input signals (x1, x2); forming the parity of the XOR operation of the input signals (x1, x2) with the aid of the following formula and providing a parity signal: Parity(XOR(x1,x2)) providing a device for checking the parity (C); calculating the XOR operation of the carried parities (Parity(x1), Parity(x2)) of the input signals (x1, x2) with the aid of the device for checking the parity, using the following formula: XOR(Parity(x1), Parity(x2)); checking the parity with the aid of the device for checking the parity, using a check of the truth of the following formula: XOR(Parity(x1), Parity(x2))==Parity(XOR(x1,x2); and detecting an error in routes and calculations within the FPGA in the presence of an untrue statement of the formula in the preceding step.

An idea of the present invention is to use the properties of parity also for checking computation operations and routes within the FPGA. In this regard, the parities of the two inputs of a computation operation are to be set in relation to the parity of the result of the computation operation to be able to detect a bit error. Bit errors may be detected thereby on the entire FPGA route from the last computation operation to the present computation operation, including any flip-flops (registers) that may be used for pipelining, as well as errors in the present computation operation. The route within an FPGA is defined by the FPGA configuration, i.e., set SRAM bits in switch boxes, for example. Since a signal and its parity combined are at least 2 bits wide, two routes between two computation operations always exist with this invention. A bit error of the configuration of the routing logic in the FPGA which influences only one of the two routes is thus also detectable, since the parity and signal no longer match. This is an important aspect, since the majority share of configurable bits in the FPGA are in the routing logic. If one were to check the parity at the beginning and end of a route, this would be a much higher overhead, and the logic and flip-flops (registers) used in the computation operation would not be protected thereby. A computer-implemented method is therefore described, which permits the detection of errors in routes and calculations in the FPGA on the basis of parity checks with low overhead (between ˜17% and ˜50%). One bit error (or an odd number of bit errors) per route and elementary computation operation may be detected thereby per clock period. To protect the computation operations, intermediate results of a computation operation present at certain points are extracted and subjected to a successive parity check. With the exception of a few logic operations, such as SHIFT and XOR, computation operations are parity-variant, i.e., the output parity may not be inferred from two input parities in most logic operations. In the case of SHIFT, a parity variance is present provided that no bits are shifted out of the data word, but rather either the data word is expanded accordingly or a rotating SHIFT is used. Addition is the most elementary mathematical operation, to which a multiplicity of computation operations may be reduced. A parity-invariant additional result is added to the parity-variant addition, which is produced from intermediate results of the addition generated only through parity-invariant operations, and a minimal overhead in further parity-invariant operations. In the case of addition, the additional result is an addition without a carry, i.e., an XOR.

The parity check for the addition takes place with the aid of a device for checking the parity, which may be a simple arithmetic unit, based on the following formula (1), which must be valid:

XOR(Parity(x1),Parity(x2))==Parity(XOR(x1,x2)) (1)

Parity(XOR(x1,x2)) can be formed directly after the computation operation, the parity signal accompanying the data signal up to a next computation operation, parity-invariant operations being passed through only by the data signal, the parity signal passing through parity-invariant operations only in the case of registers, and value-changing operations not being applied to the parity signal, registers in the parity signal being inserted according to a delay in the computation operation. If one were to form Parity(xN) only directly prior to the next operation, it would not be possible to detect parity errors on the route between the two operations. (And this route should, after all, contain even parity-invariant operations, such as registers/flip-flops or shifts.) If the parity were to be established only directly before the next operation, it would be calculated with the already corrupted signal. The erroneous signal and erroneous parity then match up, and the operation would not be able to detect the error on the previous route. The complete routing as well as all computation operations of an FPGA application are protected by checksums. One bit error per parity safe region=1 route+1 sub-operation in the FPGA may be detected in each clock pulse. Due to this fine granulation, routes and intermediate steps may be protected with 50% overhead. This has not previously been possible with the aid of the methods known from the prior art.

The method can include the additional step: initiating measures in the presence of an error in routes and calculations within the FPGAs.

It may also be provided, in particular, that the step of initiating measures in the presence of an error in routes and calculations within the FPGA comprises the following measures: aborting a simulation on the FPGA; partially reconfiguring an affected route and an affected computation operation on the FPGA to correct bit errors in configuration switch boxes and/or LUTs; and/or repeating the execution of a computation operation on the FPGA to correct bit errors in flip-flops. To prevent a functional or parameter failure in the FPGA, different measures may thus be initiated in the presence of an error in routes or calculations within the FPGA.

The computation operation can be an addition or is reduced to the addition as the most elementary mathematic operation and implemented with the aid of at least one parity-expanded full adder for the addition. Since the addition is the most elementary mathematic operation, many other mathematic operations, such as subtraction, multiplication, division, etc., may be implemented on the basis thereof in the FPGA. An approach implemented for the addition is therefore transferable to the most important FPGA operations.

The computation operation can be a multiplication, the multiplication being reduced to the addition. Since the multiplication for binary numbers may be recorded in the simplest case as the multiple addition of shifted intermediate values selected with the bits of the other as input value, the multiplication may also be achieved as a parity-protected variant.

The object according to the invention is also achieved by a device for detecting errors in routes and calculations within an FPGA, the device comprising: an FPGA having at least one configurable logic block for processing data signals, at least one computation operation being provided in the configurable logic block, the computation operation being provided with the aid of at least one full adder, a parity-invariant additional result being added to the full adder, the parity-invariant additional result being provided by picking off an XOR bit of an XOR operation of the full adder, the XOR operation comprising at least two input signals (x1, x2).

The device being configured to form the parity of the XOR operation of the input signals (X1, X2) with the aid of the following formula and to provide a parity signal:

Parity(XOR(x1,x2))

The device for detecting errors in routes and calculations within an FPGA comprising a device for checking the parity, the device for checking the parity being configured to calculate the XOR operation of the carried parities (Parity(x1), Parity(x2)) of the input signals (x1, x2) with the aid of the following formula:

XOR(Parity(x1),Parity(x2))

and the device for checking the parity being further configured to check the parity by means of a check of the truth of the following formula:

XOR(Parity(x1),Parity(x2))==Parity(XOR(x1,x2)),

and the device for detecting errors in routes and calculations within an FPGA being further configured to detect an error in routes and calculations within the FPGA in the presence of an untrue statement of the preceding formula.

According to a further aspect, the invention also relates to a computer-implemented method, the computer-implemented method at least temporarily converting an FPGA model, prior to an FPGA build, into an FPGA model with a method for detecting errors in routes and calculations within an FPGA, parity-variant computation operations being replaced in the model by a variant based on the at least one full adder, as described above.

The invention also relates to a method for operating a computer system, the computer system comprising at least one real-time computer including an FPGA, the method comprising the following steps: replacing parity-variant computation operations with parity-expanded computation operations based on the at least one full adder in an FPGA model; compiling the FPGA model; initializing the FPGA with the compilation, based on the FPGA model; carrying out a measurement operation and/or a control operation and/or a regulation operation with the aid of the real-time computer.

According to a further aspect, the invention also relates to a method for operating a computer system, the computer system comprising at least one system-on-chip FPGA, the method comprising the following steps: replacing parity-variant computation operations with parity-expanded computation operations based on the at least one full adder according to one of claims 1 through 6 in an FPGA model; compiling the FPGA model; initializing the FPGA with the compilation, based on the FPGA model; carrying out a measurement operation and/or a control operation and/or a regulation operation with the aid of the system-on-chip FPGA. System-on-chip FPGAs (SoC) are a combination of a hardware processor (hard IP core) and an FPGA structure on a chip. The integrated processor cores may be used as real-time computers and thus carry out a measurement operation and/or a control operation and/or a regulation operation.

The method can be used in rapid control prototyping applications and/or hardware-in-the-loop applications.

According to a further aspect, the invention also relates to a computer program product, comprising commands which prompt the device to carry out the method steps for detecting errors in routes and calculations within an FPGA.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a block diagram of a triple modular redundancy circuit from the prior art;

FIG. 2 shows the structure of an XOR(x1, x2) operation;

FIG. 3 shows the structure of a parity checker of an addition according to an example of the invention;

FIG. 4 shows the structure of a parity-safe 8-bit adder, including pick-offs of the pure XOR bit operation from full adders according to an example of the invention;

FIG. 5 shows the structure of a full adder from FIG. 4 in detail according to an example of the invention;

FIG. 6 shows the structure of a parallel multiplier for 4 bits;

FIG. 7 shows the structure of a parallel parity-safe multiplier for 8 bits with a parity check according to an example of the invention;

FIG. 8 shows a full adder, to which is added a parity-invariant additional result for 8 bits from FIG. 7, including a parity check according to an example of the invention;

FIGS. 9A and 9B show two block diagrams of an FPGA, a non-parity-protected FPGA being shown in FIG. 9A, and an FPGA protected with the aid of parities, parity checks, and parity-safe operations being shown in FIG. 9B; and

FIG. 10 shows a block diagram of a parity-safe FPGA in which complex operations are reduced to parity-safe operations according to an example of the invention.

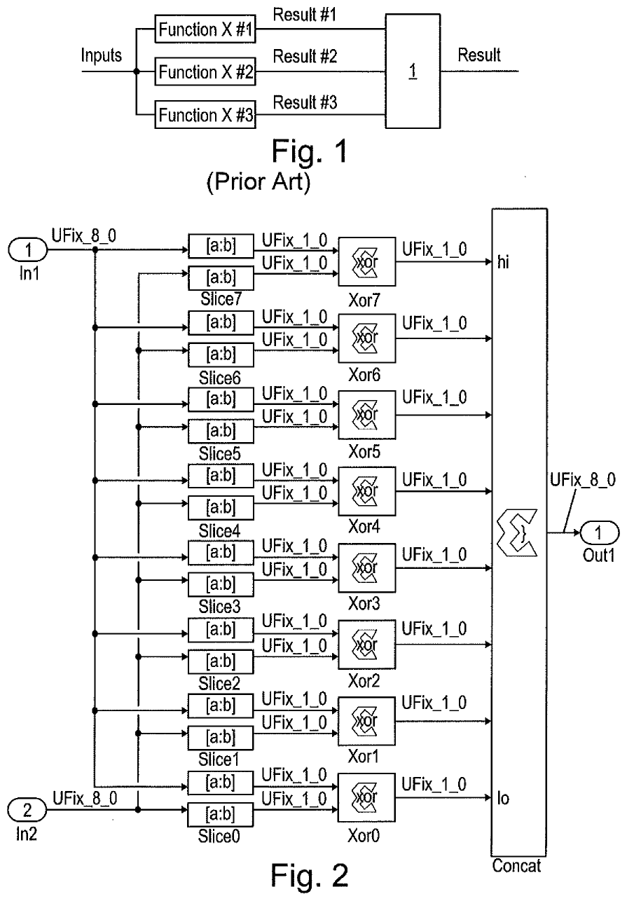

### DETAILED DESCRIPTION

An FPGA is an integrated circuit in digital technology, to which a logical circuit may be loaded. For this purpose, the FPGA comprises a configurable logic block for processing data signals. At least one computation operation is provided in the configurable logic block, the computation operation being implemented with the aid of at least one full adder. The way in which the addition may be expanded to a parity-safe operation is explained below, referred to here as “ParityAdd.” The computation operation is thus an addition or is reduced to the addition as the most elementary mathematic operation and implemented with the aid of at least one parity-expanded full adder for the addition.

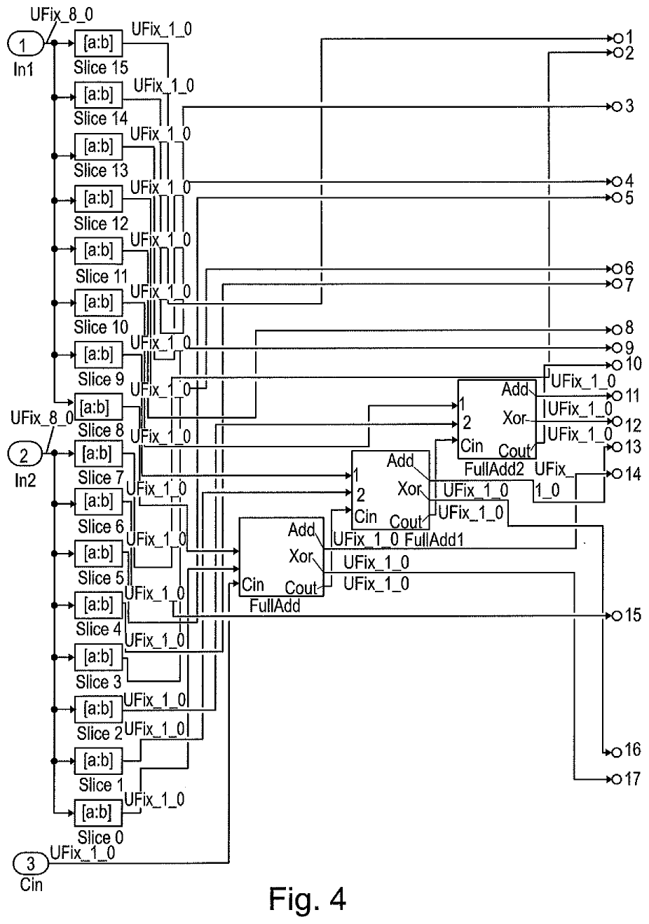

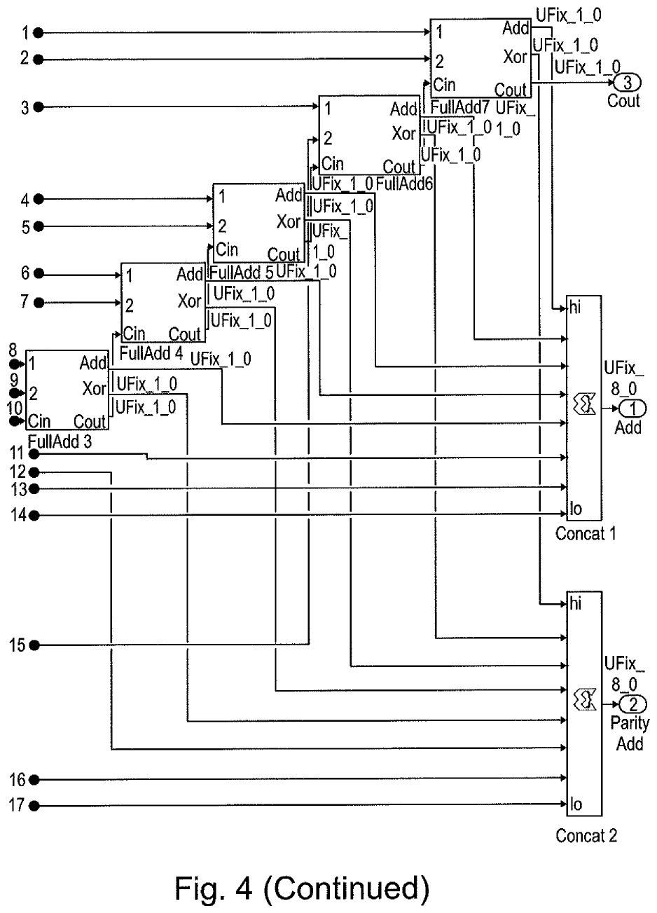

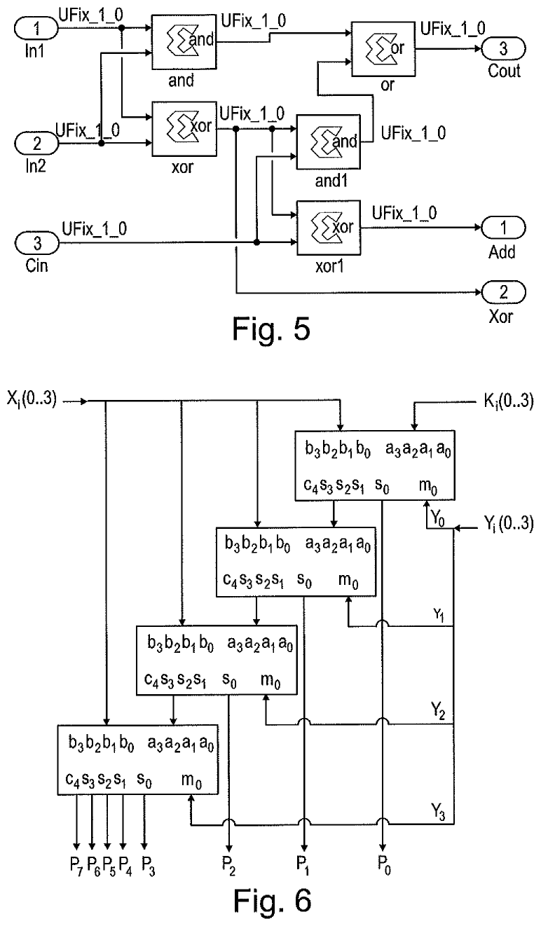

For this purpose, an XOR operation having two input signals x1 and x2 (in this case, in 8 bits as an example) is illustrated in FIG. 2. It is apparent that this is a reduced addition. In terms of bits, this takes place in the same manner as in an addition, however a handling of the carries from bit to bit is omitted. This means that the XOR operation is part of the addition, the individual result bits of the XOR operation being able to be obtained almost without cost from the addition, as illustrated farther below by the ParityAdd in FIGS. 4 and 5. Table 1 shows the parity properties of the XOR logic operation used in the ParityAdd.

TABLE 1

| Parity(x1) | Parity(x2) | Parity(XOR(x1, x2)) |
|---|---|---|
| 0 | 0 | 0 |
| 0 | 1 | 1 |
| 1 | 0 | 1 |
| 1 | 1 | 0 |

Table 1 is to be read as follows, for example for row 2, illustrated with the sample values x1=0b101 and x2=0b001 in binary notation:

x1=0b101,Parity(x1)=0,

x2=0b001,Parity(x2)=1,

XOR(x1,x2)=0b100,

Parity(XOR(x1,x2))=Parity(0b100)=1

The properties of logic operations of parities are illustrated in Table 2 below.

TABLE 2

| Parity | Parity | XOR(Parity(x1), | AND(Parity(x1), | OR(Parity(x1), |
|---|---|---|---|---|
| (x1) | (x2) | Parity(x2)) | Parity(x2)) | Parity(x2)) |
| 0 | 0 | 0 | 0 | 0 |
| 0 | 1 | 1 | 0 | 1 |
| 1 | 0 | 1 | 0 | 1 |
| 1 | 1 | 0 | 1 | 1 |

In this case, for example, the XOR operation in column 3 supplies the identical result as column 3 in Table 1. This means that formula (1) applies:

XOR(Parity(x1),Parity(x2))==Parity(XOR(x1,x2) (1)

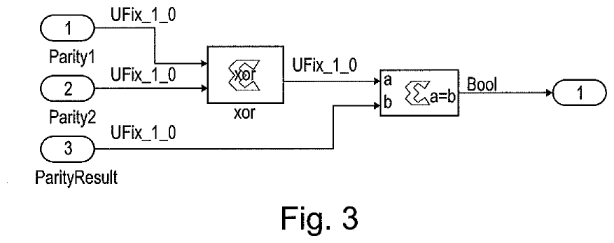

As explained in the description of FIG. 2, the right part of formula (1) may be obtained almost without cost from the arithmetic unit of the addition. Only the parity of the addition result must therefore be formed. In one exemplary embodiment of the invention, a so-called parity check according to FIG. 3 may then be designed thereby, which checks formula (1) for truth and thus protects the route up to the addition operation as well as the addition itself. For this purpose, FIG. 3 shows the structure of a parity checker of an addition according to one exemplary embodiment of the invention. The XOR operation is applied to Parity1, Parity2, subsequently compared with ParityResult, and the result is output.

FIG. 4 shows the structure of an 8-bit parity-safe adder, including pick-offs of the pure XOR bit operation from eight full adders according to one exemplary embodiment of the invention. A full adder is a combinational logic circuit, which is usually implemented as a digital circuit. It is made up of three inputs In1, In2, Cᵢₙ and two outputs Add, Cₒᵤₜ. Three single-digit binary numbers may be added up with the aid of a full adder. Output Add supplies the low-order digit of the result, while output Cₒᵤₜ supplies the high-order digit. Identifiers Cᵢₙ and Cₒᵤₜ suggest one possibility for handling the carry in adders. Each full adder additionally comprises a pick-off of the XOR bit operation, which is subsequently provided to the output ParityAdd.

FIG. 5 shows the structure of a full adder from FIG. 4 in detail according to a further exemplary embodiment of the invention. The full adder illustrated in FIG. 5 comprises the three inputs In1, In2, and Cᵢₙ and the three outputs Cₒᵤₜ, Add and Xor. The pick-off of the XOR bit operation from the XOR of the full adder is furthermore shown.

As described above, the computation operation provided in the configurable logic block is an addition or is reduced to the addition as the most elementary mathematic operation and implemented for the addition with the aid of at least one parity-expanded full adder. In one exemplary embodiment, the computation operation may also be a multiplication, the multiplication being reduced to the addition. The parity properties of the multiplication (ParityMult) are explained below, the multiplication being reduced to the addition. In digital technology, a multiplier is an electrical circuit, which ascertains the product of two or more digital numbers with the aid of the mathematical operation of multiplication. Full adders may be used to build multipliers. In the simplest case, the multiplication for binary numbers may be noted as the multiple addition of a shifted intermediate value selected with the bit of the other input value. A preferred—because it is faster—parallel implementation of the multiplication is illustrated for a 4-bit multiplier in FIG. 6. The multiplier shown in FIG. 6 comprises 4 controllable adders.

The binary multiplication runs similarly to that in decimal systems and may be implemented in digital circuits as a sequence of additions and shift operations. An unsigned, parallel multiplier (MAC) for two numbers X and Y, each four bits wide, and the summand K with full adders are illustrated in the adjacent circuit. The eight output bits P are formed in the combinational logic with the following equation:

P=X·Y+K

This simple multiplier may be implemented from individual full adders and the shift operation by direct interconnection. The binary digits of product P are equal to the sum of the digits of the two factors X and Y. A fixed-position decimal point is generally not mapped in circuitry, but rather the position of the decimal point in the product results from the sum of the digits after the decimal place of the two input factors. In the above example, the number of digits after the decimal place in both factors is zero, whereby the decimal point is placed to the right of the last digit in the product as well.

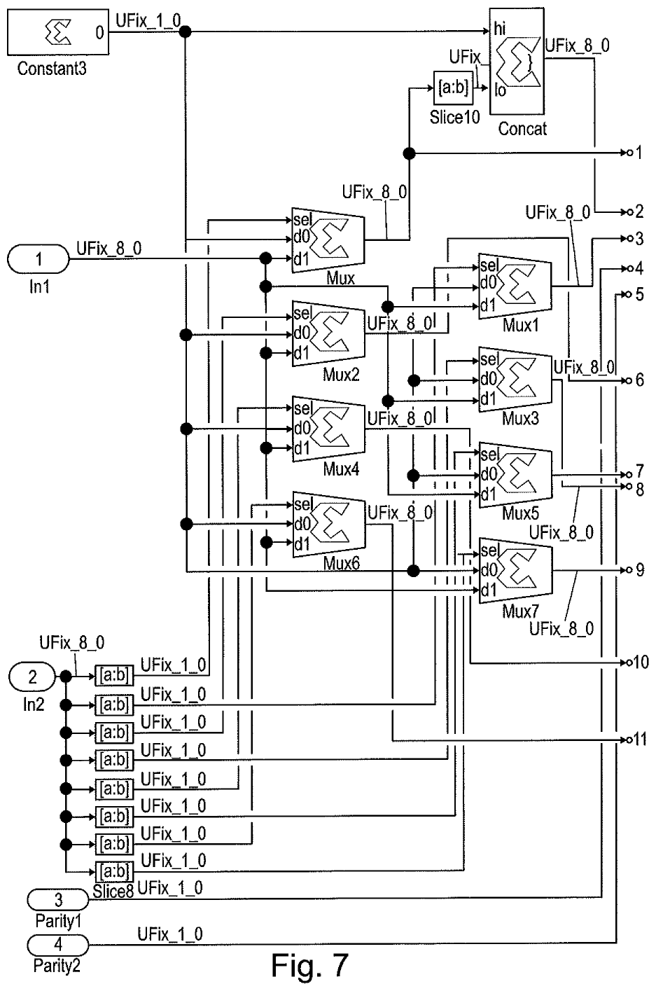

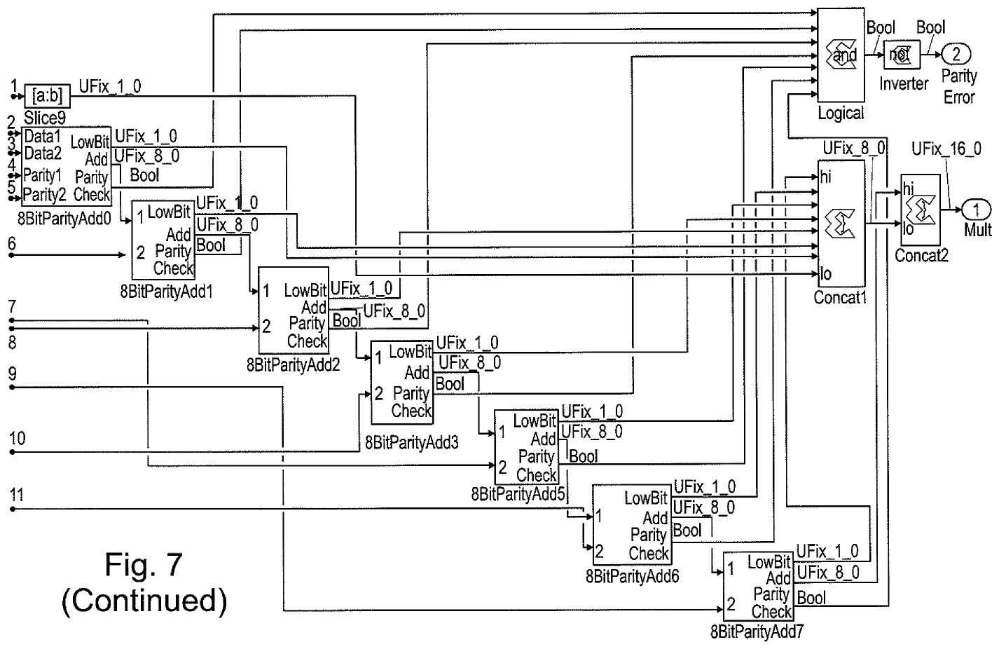

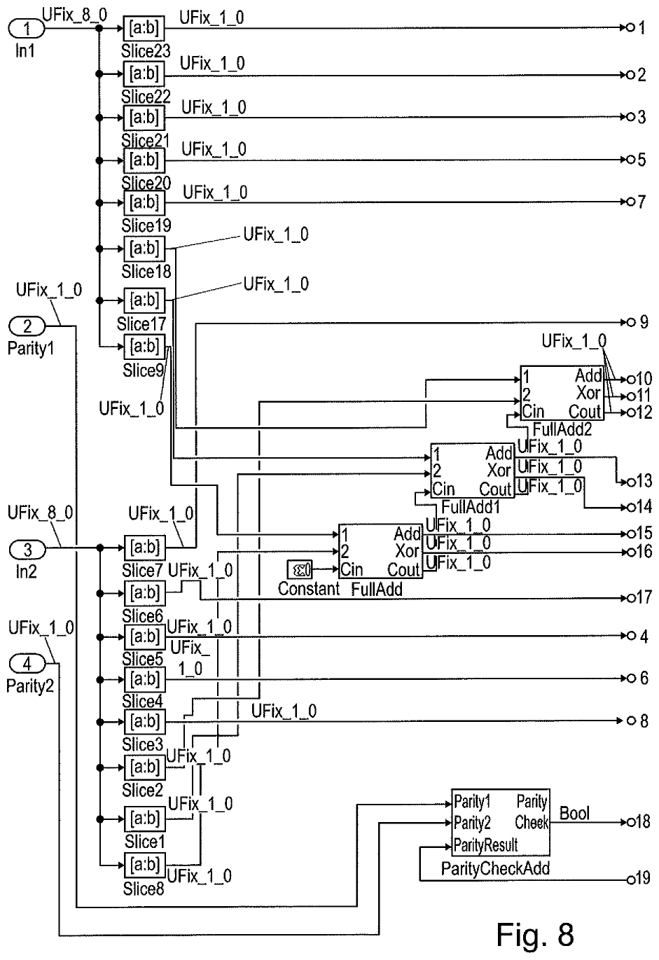

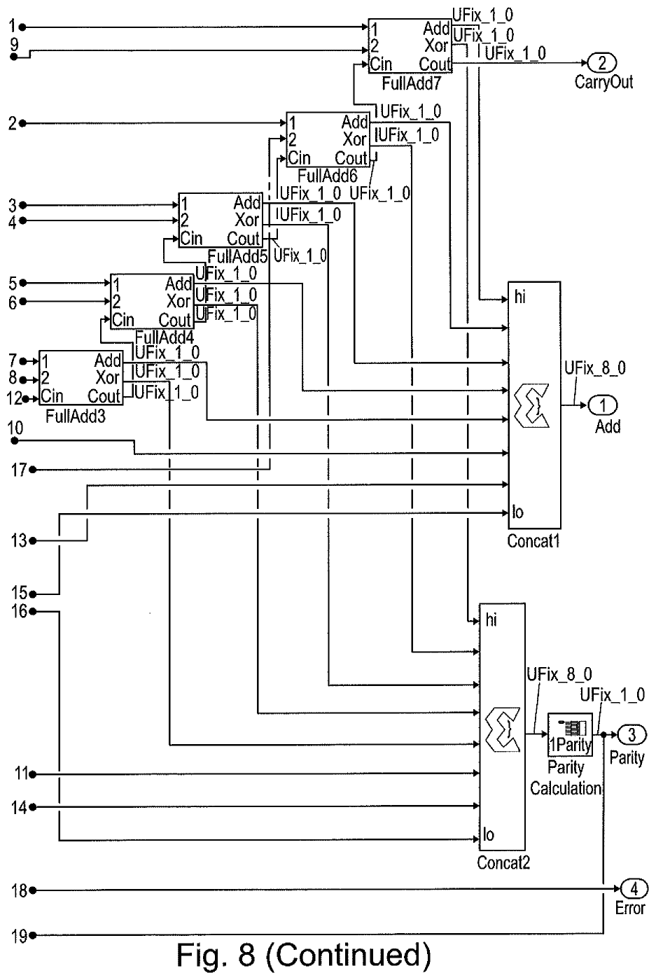

On this basis, FIG. 7 and FIG. 8 show how an 8-bit parity-safe multiplier ParityMult may be structured from the ParityAdd additions described above. It is apparent in FIG. 7 that the routes of input signals In1 and In2 are each protected by parities, via the input parities Parity1 and Parity2 as well as the intermediate results. The check of the intermediate results also increases security against multiple bit flips, compared to checking the input and output values exclusively. Regardless of whether it is signed, binary-point, or floating-point, each multiplication may be reduced to XOR and Add, and therefore ParityAdd. Each of the ParityAdds comprises a ParityCheck device for checking the parity. The functioning of the ParityAdd as well as the device for checking the parity are described in greater detail below with reference to FIG. 8.

A ParityAdd for 8 bits from FIG. 7, including a parity check according to one exemplary embodiment of the invention, is shown in FIG. 8. A computation operation is first provided in a configurable logic block, the computation operation being implemented with the aid of at least one full adder. FIG. 8 shows that the ParityAdd for 8 bits is made up of eight full adders. A parity-invariant additional result is added to the full adders, the parity-invariable additional result being provided by picking off an XOR bit of an XOR operation of the full adder. The XOR operation comprises at least two input signals (x1, x2). The parity of the XOR operation of the input signals (x1, x2) is then calculated with the aid of the following formula Parity(XOR(x1,x2)), and a corresponding parity signal is provided. FIG. 8 also shows that the ParityAdd comprises a device for checking the parity, a parity checker. The parities of the two inputs In1 and In2 are provided to inputs Parity1 and Parity2 of the parity checker. The XOR operation of the carried parities (Parity(x1), Parity(x2)) of the input signals (x1, x2) are then calculated with the aid of the parity checker, using the following formula: XOR(Parity(x1), Parity(x2)). The parity is subsequently checked with the aid of the parity checker, using a check of the truth of the following formula: XOR(Parity(x1), Parity(x2))==Parity(XOR(x1,x2). The result of the comparison with the aid of the parity checker is output as an error signal in FIG. 8. An error in routes and calculations within the FPGA in the presence of an untrue statement of the formula in the preceding step may be detected hereby and corresponding counter-measures initiated. For example, a partial reconfiguration of the FPGA may be carried out. In particular, it is apparent in FIG. 8 that the parity is passed on in parallel to the data signals CarryOut and Add.

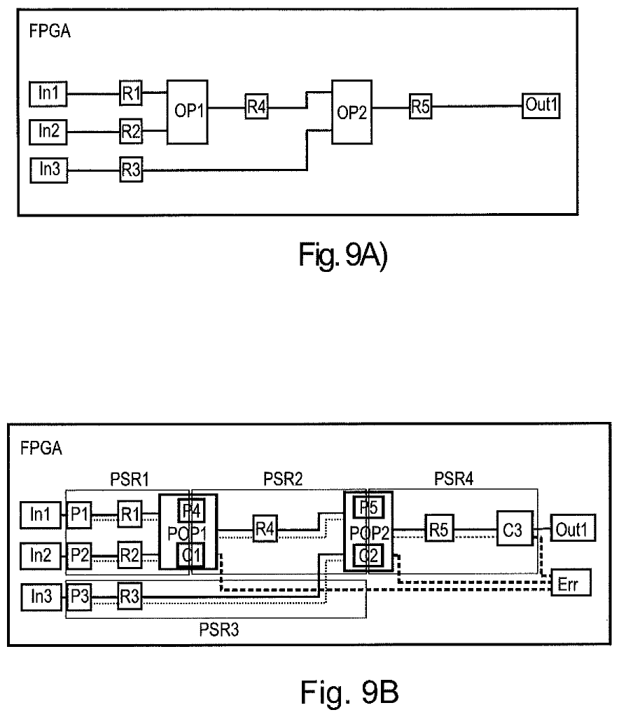

An automatic model modification and a functional representation of an FPGA are described below, an FPGA model being at least temporarily converted, prior to an FPGA build, into an FPGA model having a method for detecting errors in routes and calculations within an FPGA, using a computer-implemented method. Parity-variant computation operations are replaced in the model by a variant based on a full adder, as described above. In particular, it may be provided that the parity-protected calculations are automatically inserted into the FPGA model. FIG. 9 shows two block diagrams of an FPGA, a non-parity-protected FPGA being shown in FIG. 9 a), and an FPGA protected with the aid of parities, parity checks, and parity-safe operations being shown in FIG. 9 b) according to one exemplary embodiment of the invention. The FPGA illustrated in FIG. 9 a) comprises multiple inputs In1, In2, In3, multiple registers R1, R2, R3, R4, and R5, as well as two operations OP1 and OP2. The individual elements are connected to each other by signal lines, the signals being output at output Out1.

FIG. 9 b) shows a block diagram of an FPGA protected with the aid of parities, parity checks, and parity-safe operations according to one exemplary embodiment of the invention. A parity bit, which accompanies the data and is able to traverse parity-invariant operations, such as register R on the route, with the data, is calculated for each input In1, In2, In3 (e.g., bus interface, I/O channel) in blocks P1, P2, P3, P4, P5. The operations on the calculation path are replaced by parity-safe operations POP. The FPGA brings its strength to bear here: The logic of operations may be easily expanded to a minimal extent at arbitrary internal points to provide bits for the parity check and to carry out parity check C, as described above. Blocks In1, In2, In3 represent the original FPGA application or also a Simulink model of the FPGA application. Added blocks P1, P2, P3, P4, P5, C1, C2, C3, Err convert the FPGA application, or the Simulink model of the FPGA application, into a parity-safe FPGA application. In one exemplary embodiment, it is provided to convert, if desired, prior to the FPGA build, (Simulink) models which a user has modeled into a temporary parity-safe FPGA model and to build them in an intermediate step. For example, the user may thereby use the check box next to the “FPGA Build” to choose whether s/he would like to build a parity-safe FPGA application.

It is apparent in FIG. 9 that the parity is formed by blocks P1, P2, P3, P4, P5 directly after an input or the computation operation in each case. In particular, FIG. 9 b) shows that the parities, the dotted lines, are conducted through the FPGA in parallel to the signal lines, the solid lines. The parities accompany the data signal up to the next operation, it being possible for parity-invariant operations to be present on the path. The parity signal also runs through them in the case of registers/flip-flops. Value-changing operations are not applied to the parity signal, only their registers/flip-flops which may be necessary for pipelining. Routes and operations are parity-protected thereby, and parity-safe regions PSR1, PSR2, PSR3 result, which cover the entire FPGA until the signals are output again at output Out1 (e.g., bus interface, I/O channel). A detection is signaled the error bus Err. A detected error may also initiate, for example, the following measures. For example, an abort/failsafe of the simulation may be initiated; it is also possible, for example, to initiate a partial reconfiguration of the affected path and the computation operation for correcting bit errors in configuration switch boxes/LUTs. In a further exemplary embodiment, it may be provided that the affected computation operation is carried out again to correct bit errors in flip-flops.

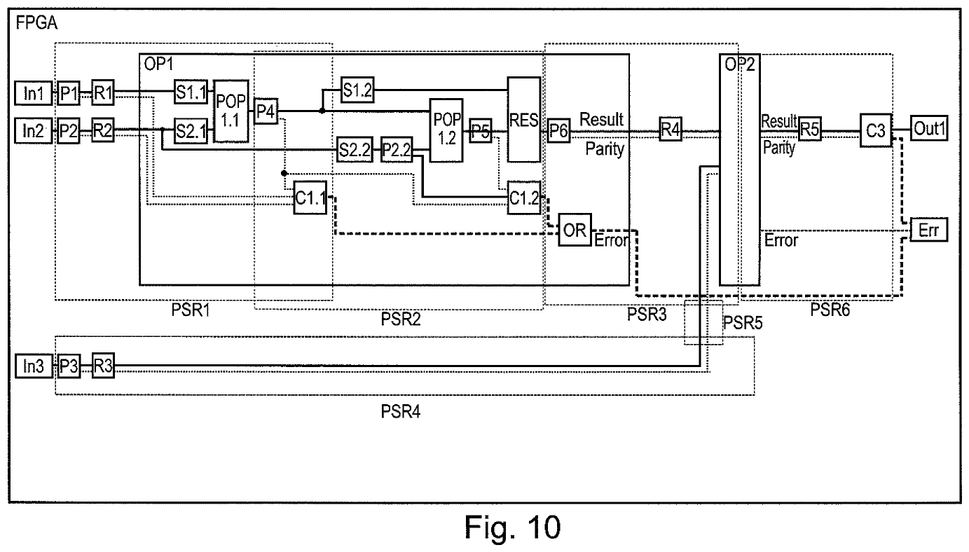

FIG. 10 shows, in one exemplary embodiment of the invention, for example, how complex operations OP1, OP2 are reduced to parity-safe operations POP 1.1, POP 1.2. In this exemplary embodiment, the routes and operations are also parity-protected thereby, resulting in parity-safe regions PSR1, PSR2, PSR3, PSR4, PSR5, PSR6 which cover the entire FPGA.

A method is also provided for operating a computer system. The computer system comprises at least one real-time computer, including an FPGA or a system-on-chip FPGA (SoC), whose integrated processor cores are used as real-time computers. The method includes the following steps. In a first step, parity-variant computation operations are replaced by parity-expanded computation operations in an FPGA model, based on the at least one full adder, as described above. The FPGA model is compiled in step 2. The FPGA with the compilation is initialized in step 3, based on the FPGA model. A measurement operation and/or a control operation and/or a regulation operation may then be carried out with the aid of the real-time computer. For example, the real-time computer may be used for rapid control prototyping applications and/or hardware-in-the-loop applications.

All features explained in connection with individual specific embodiments of the invention may be provided in different combinations in the subject matter according to the invention to implement their advantageous effects simultaneously, even if they were described in relation to different specific embodiments.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for detecting errors in routes and calculations within an FPGA, the method comprising:
providing an FPGA with at least one configurable logic element for processing data signals;
providing at least one computation operation in the configurable logic block, the computation operation being implemented with the aid of at least one full adder, a parity-invariant additional result being added to the full adder, the parity-invariant additional result being provided by picking off an XOR bit of an XOR operation of the full adder, the XOR operation comprising at least two input signals;
forming the parity of the XOR operation of the input signals with the formula Parity(XOR(x1,x2));
providing a parity signal;
providing a device for checking the parity;
calculating the XOR operation of the carried parities (Parity(x1), Parity(x2)) of the input signals via the device for checking the parity, using the following formula: XOR(Parity(x1), Parity(x2));
checking the parity via the device for checking the parity, using a check of the truth of the following formula: XOR(Parity(x1), Parity(x2))==Parity(XOR(x1,x2); and
detecting an error in routes and calculations within the FPGA in the presence of an untrue statement of the formula in the preceding step.

2. The method according to claim 1, wherein the parity: Parity(XOR(x1,x2)) is formed directly after the computation operation in each case, the parity signal accompanying the data signal up to a next computation operation, parity-invariant operations being passed through only by the data signal, the parity signal passing through parity-invariant operations only in the case of registers, and value-changing operations not being applied to the parity signal, registers in the parity signal being inserted according to a delay in the computation operation.

3. The method according to claim 1, wherein the method further comprises: initiating measures in the presence of an error in routes and calculations within the FPGAs.

4. The method according to claim 3, wherein the step of initiating measures in the presence of an error in routes and calculations within the FPGA comprises:
aborting a simulation on the FPGA;
partially reconfiguring an affected route and an affected computation operation on the FPGA to correct bit errors in configuration switch boxes and/or LUTs; and
repeating the execution of a computation operation on the FPGA to correct bit errors in flip-flops.

5. The method according to claim 1, wherein the computation operation is an addition or is reduced to the addition as the most elementary mathematic operation and implemented with the aid of at least one parity-expanded full adder for the addition.

6. The method according to claim 5, wherein the computation operation is a multiplication, the multiplication being reduced to the addition.

7. A device to detect errors in routes and calculations within an FPGA, the device comprising:
an FPGA having at least one configurable logic block for processing data signals;
at least one computation operation being provided in the configurable logic block, the computation operation being provided with the aid of at least one full adder, a parity-invariant additional result being added to the full adder, the parity-invariant additional result being provided by picking off an XOR bit of an XOR operation of the full adder, the XOR operation comprising at least two input signals,
wherein the device is configured to form the parity of the XOR operation of the input signals via the Parity(XOR(x1,x2)), and to provide a parity signal,
wherein the device for detecting errors in routes and calculations within an FPGA comprises a device for checking the parity, the device for checking the parity being configured to calculate the XOR operation of the carried parities (Parity(x1), Parity(x2)) of the input signals via the formula: XOR(Parity(x1), Parity(x2)),
wherein the device for checking the parity being further configured to check the parity by a check of the truth of the formula: XOR(Parity(x1), Parity(x2))==Parity(XOR(x1,x2)), and
wherein the device for detecting errors in routes and calculations within an FPGA being further configured to detect an error in routes and calculations within the FPGA in the presence of an untrue statement of the preceding formula.

8. A computer-implemented method, the computer-implemented method at least temporarily converting an FPGA model, prior to an FPGA build, into an FPGA model with a method for detecting errors in routes and calculations within an FPGA, parity-variant computation operations being replaced in the model by a variant based on the at least one full adder according to claim 1.

9. A method for operating a computer system, the computer system comprising at least one real-time computer including an FPGA, the method comprising:
replacing parity-variant computation operation with parity-expanded computation operations based on the at least one full adder according to claim 1 in an FPGA model;
compiling the FPGA model;
initializing the FPGA with the compilation, based on the FPGA model; and
carrying out a measurement operation and/or a control operation and/or a regulation operation with the aid of the real-time computer.

10. A method for operating a computer system, the computer system comprising at least one system-on-chip FPGA, the method comprising:
replacing parity-variant computation operations with parity-expanded computation operations based on the at least one full adder according to claim 1 in an FPGA model;
compiling the FPGA model;
initializing the FPGA with the compilation, based on the FPGA model; and
carrying out a measurement operation and/or a control operation and/or a regulation operation with the aid of the system-on-chip FPGA.

11. The method according to claim 9, wherein the method is used for rapid control prototyping applications and/or hardware-in-the-loop applications.

12. A computer program product, comprising commands which prompt a device to carry out the method according to claim 1.
